(19) United States
(12) Patent Application Publication
(10) Pub. No.: US 2024/0209997 A1
(43) Pub. Date: Jun. 27, 2024

(54) THIN-PROFILE, LIGHT-EMITTING WEARABLE DEVICE

(71) Applicant: Jason S. Martinez, Las Vegas, NV (US)

(72) Inventor: Jason S. Martinez, Las Vegas, NV (US)

(21) Appl. No.: 18/088,032

(22) Filed: Dec. 23, 2022

(51) Int. Cl. F21L 4/08; A45D 31/00; F21V 33/00; G02C 7/04; G02C 11/04

(52) U.S. Cl. CPC F21L 4/08; A45D 31/00; F21V 33/0004; G02C 7/046; G02C 11/04; F21W 2121/06

(57) ABSTRACT

A light-emitting wearable device is provided. The device includes a thin profile light-emitting element having a top and a bottom. The light-emitting element has a first thin layer light emitter and a second thin layer power source electrically coupled to the light emitter. The device further includes a first covering layer over the top of the light-emitting element and a second covering layer over the bottom of the light-emitting element. The light-emitting wearable may be configured as a lens to be worn on the eye or as a fingernail cover.

### FIELD OF THE INVENTION

The present invention relates to accessories which may be worn by an individual.

### BACKGROUND OF THE INVENTION

Wearable elements or accessories, such as rings, necklaces, ear-rings, and piercings, are known. These accessories come in a variety of styles, including materials, colors and the like. However, consumers still seek new and exciting ways to make themselves appear more attractive or interesting, such as to others. It is with respect to these and other considerations that the instant disclosure is concerned.

### SUMMARY OF THE INVENTION

One aspect of the invention is directed to a light-emitting wearable device. The device includes a thin profile light-emitting element having a top and a bottom. The light-emitting element has a first thin layer light emitter and a second thin layer power source electrically coupled to the light emitter. The device further includes a first covering layer over the top of the light-emitting element and a second covering layer over the bottom of the light-emitting element.

In one embodiment, the light-emitting wearable device may be configured as a lens which may be worn on the eye of the wearer.

In another embodiment, the light-emitting wearable device may be configured as a fingernail cover, such as may be worn on a fingernail.

Further objects, features, and advantages of the present invention over the prior art will become apparent from the detailed description of the drawings which follows, when considered with the attached figures.

### DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is a front view of a portion of a face of an individual, shown with a wearable device exploded from an eye of the individual, and the individual wearing a wearable device in another eye.

FIG. 1B is an exploded isometric view of the wearable device of FIG. 1A.

FIG. 2A is an isometric view of two fingers of an individual, shown with the individual wearing a wearable device on one finger, and shown with a wearable device exploded from another finger.

FIG. 2B is an exploded isometric view of the wearable device of FIG. 2A.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

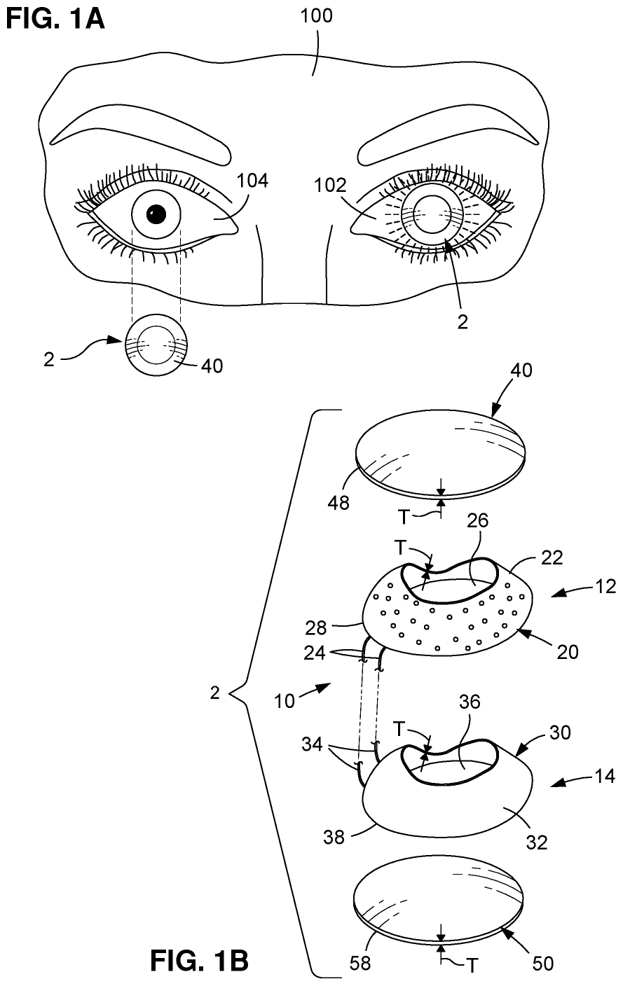

One embodiment of the invention is a light-emitting wearable device 2, as shown in FIG. 1A. In one embodiment, the light-emitting wearable device 2 may have a thin profile and be self-powered. In this manner, the wearable device 2 may be configured to be worn on or over an eye of an individual, on or over a fingernail, or other part of the body.

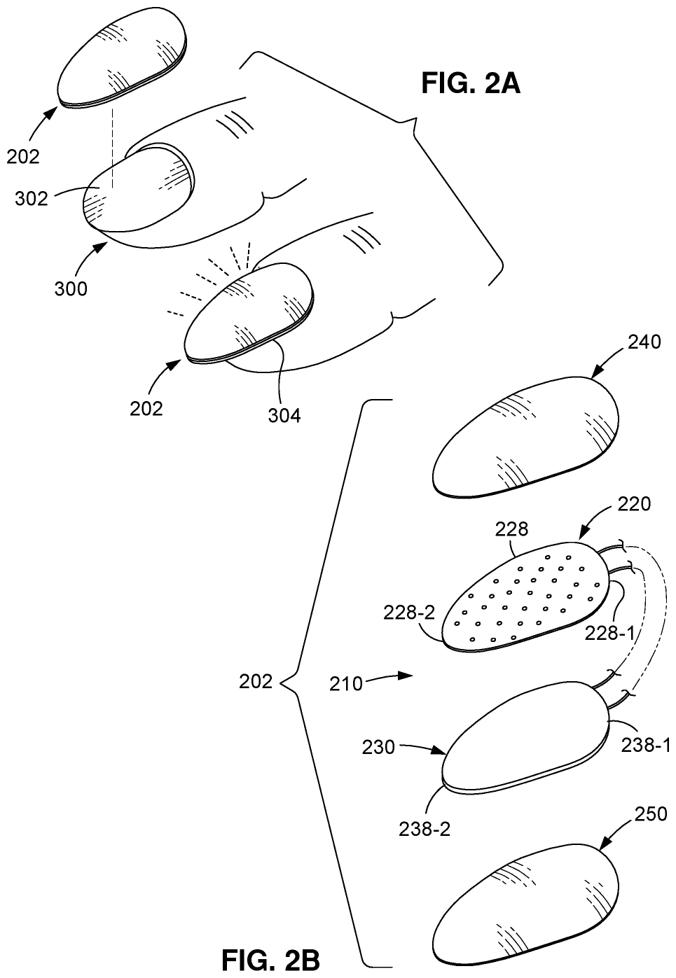

As one example of the invention, see FIG. 1A, wherein one of the wearable devices 2 is being worn (e.g., in the same manner in which traditional contact lenses are worn on the eyes of individuals) on a first eye 102 of an individual 100, and another one of the wearable devices 2 is configured to be worn on a second eye 104 of the individual 100. Accordingly, examples of the invention comprise a light-emitting wearable device 2 (e.g., a lens) which may be worn on the eye 102,104. As another example of the invention, see FIGS. 2A and 2B, wherein one of the wearable devices 202 comprises and is worn as a light-emitting fingernail cover. These and other configurations of the invention will now be described in more detail.

In one configuration, the light-emitting wearable device 2 includes a thin profile light emitting element 10 having a top 12 and a bottom 14. Additionally, in one example, the light emitting element 10 includes a first thin layer light emitter 20 and a second thin layer power source 30 electrically coupled to and configured to power the light emitter 20. The light emitter 20 and the power source 30 may be located within a protective cover or body, such as between a first covering layer 40 and a second covering layer 50. That is, the first covering layer 40 may be over the top 12 of the light emitting element 10 and the second covering layer 50 may be over the bottom 14 of the light emitting element 10.

In one example, at least one of the first and second covering layers 40,50 may be in the form of contact lenses which may be configured to be corrective, such as by having a shape and/or variation in thickness which effectuates vision correction. In other variations, the first and/or second covering layers 40,50 may be un-correcting (from a vision perspective), such as merely comprising protective layers.

The first and second covering layers 40,50 may be made of hydrogel, silicone hydrogel, or polymethyl methacrylate. In a preferred embodiment, the light emitter 20 and the power source 30 are thin in profile, such as comprising thin layers. In one example, each of the light emitter 20, the power source 30, the first covering layer 40, and the second covering layer 50 has a thickness “T”, such that the total thickness of the device 2 is preferably less than 0.4 millimeters. In this manner, it will be appreciated that the wearable device 2 may be worn on the eyes 102,104 (FIG. 1A) of the individual 100 in the exact same manner as a standard contact lens. Further yet, as will be discussed below, the wearable device 2 is configured to emit light, while still allowing the individual 100 to see.

More specifically, the light emitter 20 may be in the form of a thin film light emitting diode (LED), such as comprising a mesh LED or other light emitting element(s) 22 (of various types now known or later developed, such as which emit visible light, such as when excited by energy) and one or more electrical leads 24 (or contacts/pathways) electrically connected to the light emitting element(s) 22. In an alternative example (not shown), a light emitter may include other light emitting elements coupled to a substrate, without departing from the scope of the disclosed concept.

Additionally, the power source 30 may be positioned adjacent to, or be nested within the light emitter 20. For example, the power source 30 may comprise a thin layer element or be a power element which is thin and which is associated with a thin layer supporting body. The power source 30 may, for example, comprise a thermos-electric generator, a solar cell, and/or a battery (including a rechargeable battery—including where the battery might be inductively chargeable, such as by placing the wearable on or near an inductive charger), or combinations thereof (such as solar cell which powers a rechargeable battery).

When the wearable 2 is configured to be worn on the eye of the wearer, it is configured to be seen through. Thus, the light emitting element 10 is configured to allow the individual 100 to see through it. In one example, as shown in FIG. 1B, the power source 30 and the light emitter 20 each have a corresponding thru hole 26,36 and are each frustoconical-shaped. Moreover, the edge portions which define the thru holes 26,36 overlay one another, and are configured such that the retinas of the eyes 102,104 of the individual 100 can see therethrough. In other words, the thru holes 26,36 are concentric with each other in order to allow the individual 100 to see therethrough. However, it will be appreciated that alternative power sources and light emitters are contemplated. For example, power sources and light emitters may include transparent center portions instead of having thru holes, in order to allow the individual 100 to see therethrough, without departing from the scope of the disclosed concept.

Further yet, in one example the light emitter 20 and the power source 30 each have a corresponding perimeter 28,38, and the perimeters 28,38 overlay/are generally co-extensive with one another. Additionally, the first and second covering layers 40,50 may also have corresponding perimeters 48,58 that overlay the perimeters 28,38 of the light emitter 20 and the power source 30. It is also contemplated that the perimeters 28,38,48,58 may all be circular-shaped, thus allowing the wearable device 2 to efficiently be worn on the eyes 102,104 of the individual. Stated differently, the disclosed wearable device 2 is advantageously structured such that the four elements 20,30,40,50 comprising its construction may be joined and provide the individual 100 with a single constant perimeter. In other words, the wearable device 2 will appear to the individual 100 as being of the same profile as a standard contact lens, thus making using the wearable device 2 relatively simple (in other embodiments, the light emitter 20 might be smaller in outer dimension than the covering layers 40,50). For example, while comprising multiple elements, such as elements in layers (light emitter layer, power source layer, covering layers), the entire wearable 2 may be lens-shaped to fit onto an eye of a wearer (thus being partially spheric or toric).

Additionally, as mentioned, the power source 30 is electrically coupled to the light emitter 20. For example, the power source 30 may include a body 32 comprising or supporting a power source such as, but not limited to, a thermo-electric generator, a solar cell, battery, etc., and a number of electrical leads 34 or contacts electrically connected to the body 32. The leads 34 of the power source 30 may be electrically coupled to the leads 24 of the light emitter 20 in order to allow the power source 30 to power the light emitter 20. In this manner, the power source 30 is configured to cause the light emitter 20 to be energized and emanate light.

In one embodiment of the disclosed concept, the power source 30 is located below the light emitter 20 (e.g. the power source 30 may comprise a layer which has a top surface which is located adjacent to the bottom surface of the light emitter 20 there above), with respect to a position when coupled to the eyes 102,104 of the individual 100. In this manner, when the wearable device 2 is worn by the individual 100, light will emanate from the light emitter 20, and only have the first covering layer 40 to penetrate through before exiting the wearable device 2. Stated differently, the power source 30, in a preferred embodiment, does not block the emission of light from the light emitter 20. Accordingly, in one example the first and second covering layers 40,50 are transparent (e.g., allow visible light to pass therethrough). The first and second covering layers 40,50 may also be colored.

Moreover, in addition to the orientation of the light emitter 20 with respect power source 30, in one example the light emitter 20 has a back layer which is configured to be reflective so as to direct emitted light only out of the top of the wearable device 2 (e.g., toward the first covering layer 40 and away from the second covering layer 50). In other words, with a reflective back layer, the light emitter 20 is configured such that it does not emit rearwardly or towards the bottom, such as towards one of the eyes 102,104 of the individual 104. In another configuration, such a reflective layer may be located between the light emitter 20 and the power source 30, on or in the power source 30 (including on the top or bottom thereof), or on or in the second covering layer 50). For example, the reflective layer might comprise a light reflecting material which is associated with the second covering layer 50. Of course, in other embodiments, the light emitter 20 might be configured to illuminate or direct light in generally one direction, e.g. towards the top of the wearable and away from the eye of the wearer.

FIGS. 2A and 2B show another light-emitting wearable device 202 which is structured similar to the wearable device 2 (FIGS. 1A and 1B), and like numbers represent like features. However, while the wearable device 2 is structured as a contact style lens configured to be worn on the eyes 102,104 of the individual 100, this embodiment wearable device 202 is structured as a fingernail configured to be worn on a finger/thumb nail 302,304 (FIG. 2A) of an individual 300 (FIG. 2A). It will be appreciated that the light emitting element 210 (e.g., the light emitter 220 and the power source 230) may be configured and/or function the same as the light emitting element 10 (FIG. 1B). Accordingly, for economy of disclosure, only differences between the wearable device 202 (FIGS. 2A and 2B) and the wearable device 2 (FIGS. 1A and 1B) will be discussed hereinafter.

As shown in FIG. 2B, the perimeter 238 of the power source 230 and the perimeter 228 of the light emitter 220 each include a first end 228-1,238-1 and a second end 228-2,238-2 located opposite the first end 228-1,238-1. Additionally, the first and second ends 228-1,228-2,238-1,238-2 are concave facing each other. In one example, the first ends 228-1,238-1 have a first radius of curvature and the second ends 228-2,238-2 have a second radius of curvature less than the first radius of curvature. In other words, the light emitter 220 and the power source 230 are each fingernail-shaped (e.g., have greater concavity at one end than another). It will be appreciated that the first and second covering layers 240,250 are similarly shaped (e.g., fingernail-shaped—where the wearable 202 might come in slightly different shapes, including lengths, such as to confirm with various sizes and shapes of nails—including fingernails, thumb-nails, toe-nails, etc.).

The wearable device 202 is again preferably thin, such as by having a thickness of 0.03 inches or less.

As stated, the wearable device 202 is configured to be worn on the fingernails 302,304 of the individual 300. In one example, the wearable device 202 further includes an adhesive layer bonded to, connected to or associated with, one of the first and second covering layers 240,250, such as for use in adhering the wearable device 202 to the fingernails 302,304. In such a configuration, the wearable 202 may be self-adhesive. Of course, in other embodiments, a user might apply an adhesive, such as a liquid adhesive, to their fingernail or the bottom of the wearable, in order to adhere/affix it to their fingernail.

Accordingly, the disclosed concept has been described in association with the wearable devices 2,202 being configured similar to traditional contact lenses that are configured to be worn on the eyes 102,104 of the individual 100, and traditional fingernails configured to be worn on the nails 302,304 of the individual 300. In this manner, the wearable devices 2,202 allow the individuals 100,300 to advantageously appear more attractive and noticeable to others. For example, the wearable device 2 may cause the eyes 102,104 of the individual 100 to appear illuminated (e.g., without limitation, bright, colorful, luminescent, and/or flashing) and the wearable device 202 may similarly cause the fingernails 302,304 to appear illuminated.

Additionally, while the disclosed concept has been described herein in association with the wearable devices 2,202, other suitable alternative wearable devices are contemplated herein. For example, wearable devices (not shown) in accordance with the disclosed concept might be disc-shaped and thin in profile and have adhesive on the back so that they can be applied to the skin.

Advantageously, the light-emitting wearable is thin in profile, such as to be able to be worn on the eye without interfering with the normal functioning thereof (including opening and closing of the eyelid), on the skin or a fingernail (such as by not protruding excessively there above). Further, the light-emitting wearable is self-powered so that it can be worn and emit light without connection to a separate power source.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A light-emitting wearable device comprising:
a thin profile light-emitting element having a top and a bottom, said light-emitting element comprising a first thin layer light emitter and a second thin layer power source electrically coupled to said light emitter, and
a first covering layer over said top of said light-emitting element and a second covering layer over said bottom of said light-emitting element.

2. The light-emitting wearable device according to claim 1, wherein each of said light emitter, said power source, said first covering layer, and said second covering layer has a thickness that is less than 0.4 millimeters.

3. The light-emitting wearable device according to claim 2, wherein said light emitter comprises a mesh member.

4. The light-emitting wearable device according to claim 3, wherein said power source is nested within said light emitter.

5. The light-emitting wearable device according to claim 4, wherein each of said power source and said light emitter has a thru hole, and wherein each of said power source and said light emitter is frustoconical-shaped.

6. The light-emitting wearable device according to claim 1, wherein said light emitter and said power source each have a perimeter, and wherein the perimeter of the light emitter and the perimeter of the power source overlay one another.

7. The light-emitting wearable device according to claim 6, wherein the perimeter of said power source and the perimeter of said light emitter each comprise a first end and a second end disposed opposite the first end, wherein the first and second ends are concave facing each other, wherein the first end has a first radius of curvature, and wherein the second end has a second radius of curvature less than the first radius of curvature.

8. The light-emitting wearable device according to claim 7, wherein said first and second covering layers each have a perimeter overlaying the perimeters of said power source and said light emitter.

9. The light-emitting wearable device according to claim 1, wherein the power source is selected from the group consisting of a thermos electric generator, a solar cell, and a battery.

10. A light-emitting wearable device comprising:
a light-emitting element having a top and a bottom, said light-emitting element comprising a light emitter and a power source electrically coupled to said light emitter, and
a first covering layer over said top of said light-emitting element and a second covering layer over said bottom of said light-emitting element,
wherein at least one of said first covering layer and said second covering layer is a contact lens.

11. The light-emitting wearable device according to claim 10, wherein each of said power source and said light emitter is frustoconical-shaped.

12. The light-emitting wearable device according to claim 11, wherein said light emitter comprises a mesh member.

13. The light-emitting wearable device according to claim 11, wherein said power source is nested within said light emitter.

14. The light-emitting wearable device according to claim 11, wherein the power source is selected from the group consisting of a thermos electric generator, a solar cell, and a battery.

15. A light-emitting wearable device comprising:
a thin profile light-emitting element having a top and a bottom, said light-emitting element comprising a first thin layer light emitter and a second thin layer power source electrically coupled to said light emitter, and
a first covering layer over said top of said light-emitting element and a second covering layer over said bottom of said light-emitting element,
wherein said light emitter and said power source each have a perimeter, and wherein the perimeter of the light emitter and the perimeter of the power source overlay one another.

16. The light-emitting wearable device according to claim 14, wherein the perimeter of said power source and the perimeter of said light emitter each comprise a first end and a second end disposed opposite the first end, wherein the first and second ends are concave facing each other, wherein the first end has a first radius of curvature, and wherein the second end has a second radius of curvature less than the first radius of curvature.

17. The light-emitting wearable device according to claim 15, wherein said first and second covering layers each have a perimeter overlaying the perimeters of said power source and said light emitter.

18. The light-emitting wearable device according to claim 16, further comprising an adhesive layer bonded to one of said first covering layer and said second covering layer for adhering said wearable device to a fingernail.

19. The light-emitting wearable device according to claim 16, wherein said first covering layer and said second covering layer are transparent.

20. The light-emitting wearable device according to claim 16, wherein the power source is selected from the group consisting of a thermos electric generator, a solar cell, and a battery.
